(19) United States
(12) Patent Application Publication
(10) Pub. No.: US 2024/0171578 A1
(43) Pub. Date: May 23, 2024

(54) WEBSITE ACCESS MANAGEMENT DEVICE THROUGH CATALOGED WEB ADDRESS

(71) Applicant: Min Suk KIM, Seogwipo-si (KR)

(72) Inventor: Min Suk KIM, Seogwipo-si (KR)

(21) Appl. No.: 18/503,172

(22) Filed: Nov. 6, 2023

(30) Foreign Application Priority Data
Nov. 17, 2022 (KR) 10-2022-0154141

(51) Int. Cl. H04L 9/40; G06F 16/955

(52) U.S. Cl. CPC H04L 63/10; G06F 16/9566

(57) ABSTRACT

The present invention relates to a device for managing website access blocking and permission, which includes, as an example, a catalog storage unit that stores a permitted catalog containing URL-permitted addresses of specific websites that permit access, and a blocking catalog containing URL blocking addresses of specific websites that blocks access; a URL input address processing unit that receives transmission of a URL input address inputted or processed on an Internet browser and separately processes the transmitted URL input address into a protocol, a host address, and an actual address; a permission/blocking determination unit equipped with a determination algorithm that loads the permitted catalog and blocking catalog stored in the catalog storage unit, receives the URL input address separately processed in the URL input address processing unit, and cross-compares the URL permitted address and URL blocking address on the catalog storage unit loaded for the URL input address to derive a result on whether to permit or block access to the website connected by the URL input address; and an app control unit that integrally controls operations of the catalog storage unit, URL input address processing unit, and permission/blocking determination unit.

### TECHNICAL FIELD

The present invention relates to a device for managing website access blocking and permission by effectively cataloging a web address, and more particularly, to a device that enables even a user or an operator unaccustomed to use a computer to block and permit access to a website and perform real time inspection for harmful content more easily and efficiently in a smart and highly readable way.

### BACKGROUND ART

In an era when the Internet has become universal, users can obtain desired information by accessing to numerous sites existing on the network. However, as the amount of information on the Internet has grown and diversified day by day, the number of harmful sites such as illegal, pornographic, gambling, suicide, and adult games as a side effect resulting therefrom have also increased rapidly. Several reports have been published that such harmful sites cause mental, physical, and economic damage to adults, including children and teenagers, and even adults. Various legal devices and systems have been established to sanction this, and their intensity is also getting stronger.

Therefore, several ISPs (Internet Service Providers) and companies have introduced solutions to block harmful sites. Of these methods, the most traditional and commonly used method is to catalog the URL addresses to be blocked, and compare them with the URL addresses to which the user attempts to access, thereby determining whether to block or permit them. However, this method has the limitation that it is only useful for personal sites or sites intended to serve one business as a single URL address.

Current websites have changed their service delivery methods in line with the development of technology, their complexity, and the needs of diverse consumers. For example, for the case of a portal site, even if users accesses to the main address (OOO.com), the actual content loaded inside (scripts, images, videos, etc.) may be loaded on a subdomain, a sub-address, or even a completely different domain. This is because it is more efficient to load sources (scripts, images, videos, etc.) required from their own CDN (Content Delivery Network) or from an external separate subdomain or a third domain that serves specialized programs, rather than loading all content from a single host address (OOO.com) to their sub-concept URLs in the past. Therefore, it is now difficult to simply block a website based on a single web address or to determine and manage that it is safe.

For example, if OOO.com is to be blocked, finance.OOO.com (economic services) and jr.OOO.com (children's services), which provide services distinguished by a subdomain, are also blocked. In contrast, if OOO.com is to be permitted, blogs provided by OOO.com that should not be permitted to children may be exposed to children.

For the case of a website that is accessed to one host address in various ways with sub-domains or sub-addresses and provides a wide variety of services in this way, the length of the catalog thereof must increase significantly in order to block and permit each, which requires management, which becomes difficult to manage, and causes problems that slow down the app or program.

### PRIOR ART LITERATURE

### Patent Literature

(Patent Literature 0001) Korean Unexamined Patent Publication No. 10-2017-0049169 (published on May 10, 2017)

### DETAILED DESCRIPTION OF THE INVENTION

### Technical Problem

It is an object of the present invention to provide a device for managing website access blocking and permission that not only enables even a user or an operator unaccustomed to use a computer to manage Internet access blocking and permission even when providing multiple services with one host address or domain as a web service method that has been rapidly increasing recently, but also enables efficient use of the resources (memory, CPU, network, etc.) of the user's device (mobile device such as computer, smartphone, or tablet) through efficient cooperation with real time harmful content inspection and blocking software.

However, the objects and advantages of the present disclosure are not limited to those described above, and other objects and advantages not mentioned above will be clearly understood by those skilled in the art from the following description.

### Technical Solution

In an embodiment of the present invention, there is provided a device for managing website access blocking and permission, comprising: a catalog storage unit that stores a permitted catalog containing URL-permitted addresses of specific websites that permit access, and a blocking catalog containing URL blocking addresses of specific websites that blocks access; a URL input address processing unit that receives transmission of a URL input address inputted or processed on an Internet browser and separately processes the transmitted URL input address into a protocol, a host address, and an actual address; a permission/blocking determination unit equipped with a determination algorithm that loads the permitted catalog and blocking catalog stored in the catalog storage unit, receives the URL input address separately processed in the URL input address processing unit, and cross-compares the URL permitted address and URL blocking address on the catalog storage unit loaded for the URL input address to thereby derive a result on whether to permit or block access to the website connected by the URL input address; and an app control unit that integrally controls operations of the catalog storage unit, URL input address processing unit, and permission/blocking determination unit.

The permission/blocking determination unit determines whether to permit or block access to a website by using as the highest determination condition where the URL address matching the actual address on the URL input address is located in the permitted catalog or blocking catalog.

The permission/blocking determination unit permits access to all subdomains and sub-addresses including the host address, in a case where the host address on the URL input address is only in the permitted catalog.

In an embodiment of the present invention, the catalog storage unit may comprise a default permitted catalog and default blocking catalog that cannot be changed by the user, and a user-setting permitted catalog and use-setting blocking catalog that can be changed by the user.

Further, the catalog storage unit permits assigning a first special identifier to the permitted catalog, wherein the first special identifier specifies that the host address is the same, but the sub-address and subdomain are separate services and are processed as separate URL addresses, the permission/blocking determination unit may determine that the multi-host to which the first special identifier has been assigned permits or blocks access to the URL input address, or permits as limited access requiring real time content inspection, depending on the permitted catalog and the blocking catalog.

Further, the catalog storage unit permits registering a second special identifier that specifies blocking of access to all websites in the blocking catalog, and the permission/blocking determination unit may permit access only to the host address or real address registered in the permitted catalog, in a case where the second special identifier is registered in the blocking catalog.

Further, the permission/blocking determination unit may permit access only to a host address or real address that is the same as the URL permission address registered in the permitted catalog, while it may block access to a host address or actual address that is the same as the URL blocking address registered in the blocking catalog, in a case where the second special identifier is registered in the block catalog.

Meanwhile, according to an embodiment of the present invention, the permission/blocking determination unit first determines whether the host address is not a multi-host while being in the permitted catalog, blocks access when the actual address is in the blocking catalog in the case of corresponding thereto, while it may permit access in the other cases.

Further, the permission/blocking determination unit first determines whether the second special identifier is registered in the blocking catalog, when the host address is in the permitted catalog but does not correspond to the case where it is not a multi-host, and it determines whether the host address is registered in the permitted catalog when a second special identifier is registered, and then checks whether it is a multi-host in the case of permitted host address, while it permits access only when the actual address is in the permitted catalog in the case of a blocked host address.

The permission/blocking determination unit permits access only when the actual address is not on the blocking catalog but is on the permitted catalog, in the case of a multi-host in which a second special identifier is registered and the host address is registered in the permitted catalog, and it may determine as a limited permission that requires real time content inspection, in the case of a single host in which a second special identifier is registered and the host address is registered in the permitted catalog.

The permission/blocking determination unit may determine as a limited permission that requires real time content inspection, in a case where the second special identifier is registered and the host address is a multi-host registered in the permitted catalog, and at the same time, the actual address is not in both the blocking catalog and the permitted catalog.

Further, the permission/blocking determination unit determines whether the host address is a multi-host when the second special identifier is not registered in the blocking catalog, and may permits access only when the actual address is on the permitted catalog in a case where the address is a multi-host.

Wherein, the permission/blocking determination unit may preferably permit access when the real address is in the permitted catalog even if a URL blocking address including a sub-address in the real address is registered in the blocking catalog.

Further, the permission/blocking determination unit may determine as a limited permission that requires real time content inspection, in a case where the URL blocking address including a sub-address in the real address is not registered in the blocking catalog and the real address is not even in the permitted catalog.

Further, the permission/blocking determination unit may permit access only when the actual address is in the permitted catalog, in a case where the second special identifier is not registered in the blocking catalog and the host address is a single host in the blocking catalog.

Further, the permission/blocking determination unit may determine as a limited permission that requires real time content inspection unless the actual address is on the blocking catalog, in a case where the second special identifier is not registered in the blocking catalog and the host address is a single host that is not in the blocking catalog.

### Advantageous Effects

The access management device of the present invention having the above configuration newly defines a host that provides multiple services with a single host address or domain, which has been rapidly increasing in recent years, as a multi-host, and uses this as a standard for permission/blocking determination, cross-compare URL input addresses against the permitted catalog and the blocking catalog, and diversifies permitting or blocking access to URL input addresses, which makes it possible to realize various access management scenarios intended by the user.

In addition, the access management device of the present invention introduces a special identifier so that even a user or an operator unaccustomed to use a computer can easily manage permission and blocking for Internet access, and can improve the safety and efficiency of website access by enabling efficient use of the resources of the user's device through efficient linkage with real time harmful content inspection and blocking software.

However, effects obtainable from the present disclosure may be not limited by the above mentioned effect. And, other unmentioned effects can be clearly understood from the following description and the accompany drawings by those skilled in the art.

### BRIEF DESCRIPTION OF THE DRAWINGS

The accompanying drawings illustrate preferred embodiments of the present invention and, together with the foregoing disclosure, serve to provide further understanding of the technical spirit of the present disclosure. However, the present disclosure is not to be construed as being limited to the drawings.

FIG. 1 is a diagram showing a schematic configuration of a device for managing website access blocking and permission according to the present invention.

FIGS. 2 to 6 are flowcharts showing one embodiment of an algorithm mounted on the permission/blocking determination unit.

### DETAILED DESCRIPTION OF THE EMBODIMENTS

Embodiments of the present invention may be modified in various forms, and thus, specific embodiments will be described in detail below.

However, this is not intended to limit the present invention to specific embodiments, and it should be understood that the present invention includes all modifications, equivalents and alternatives falling within the spirit and scope of the invention.

It should be understood that the terms “comprise,” “include”, “have”, etc. are used herein to specify the presence of stated features, integers, steps, components, parts or combinations thereof, but do not preclude the presence or addition of one or more other features, integers, steps, operations, components, parts or combinations thereof.

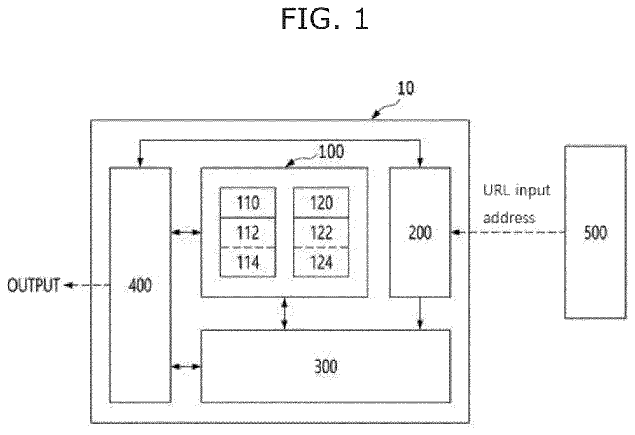

FIG. 1 schematically shows the overall configuration of a device 10 managing website access blocking and permission (hereinafter, in the detailed description of the present invention, it will be briefly referred to as “access management device”) according to the present invention.

Referring to FIG. 1, the access management device 10 of the present invention includes a catalog storage unit 100, a URL input address processing unit 200, and a permission/blocking determination unit 300 and an app control unit 400, when broadly divided based on its functions.

The catalog storage unit 100 is configured to non-volatilely store a permitted catalog 110 containing the URL permitted addresses of specific websites that permit access, and a blocking catalog 120 containing URL blocking addresses of specific websites that block access.

The catalog storage unit 100 manages information for determining whether to permit or block website access (including a limited permission to be described later) as a permitted catalog 110 and a blocking catalog 120.

As one of the features of the present invention, the catalog storage unit 100 does not simply manage permission or blocking for specific websites in a one-dimensional manner by storing either the permitted catalog 110 or the blocking catalog 120, but can store both the permitted catalog 110 and the blocking catalog 120 and utilizes them to realize a multidimensional permission/blocking scenario. Thereby, the entire website containing the domain address to be accessed is blocked, but access to specific pages of its sub-address is permitted, or various permission/blocking scenarios desired by the user including vice versa can be created. The specific scenario for this purpose will be explained in detail in the relevant section.

Further, the catalog storage unit 100 may comprise a default permitted catalog 112 and a default blocking catalog 122 that cannot be changed by the user, and a user-setting permitted catalog 114 and a use-setting blocking catalog 124 that can be changed by the user. The default permitted catalog 112 and the default blocking catalog 122 are permission/blocking catalogs stored and updated by default in the access management device 10, and for example, an addresses catalog of approved safe sites and harmful sites may be included therein. The default permitted catalog 112 and the default blocking catalog 122 are provided for the convenience of user management, and user editing such as modification or addition is not permitted, but, if necessary, the user may be imparted the option of approving or canceling whether or not the default permitted/blocking catalogs 112 and 122 is applied.

The user-setting permitted catalog 114 and the user-setting blocking catalog 124 enable the user to freely enter URL permitted addresses and URL blocking addresses, thereby realizing a permission/blocking scenario of the access management device 10 to suit the user's desired purpose. That is, the access management device 10 can be customized through the user-setting permitted/blocking catalogs 114 and 124. However, if the same address is registered in each of the user-setting permitted/blocking catalogs 114 and 124, an error or malfunction may occur in the permission/blocking determination unit 300, which will be described later. Therefore, it would be desirable for the catalog storage unit 100 to take precautionary measures such as warning or selection (registering only for any one of permission and blocking) in this case.

The URL input address processing unit 200 is configured to receive transmission of a URL input address input or processed on the Internet browser 500 and process it. In other words, when the address of the website to which the user attempts to access is inputted or processed through the Internet browser 500, the URL input address processing unit 200 functions as a window for inputting the connection information to the access management device 10. Access information for website can be generated in a variety of ways, including direct input by the user (typing or voice, etc.), clicking on a hyperlink, or automatic script execution, and such various types of connection information are transmitted to the URL input address processing unit 200.

Here, the URL input address refers to the address of the website to which the user is actually attempting to access. This is a URL address that is clearly distinguished from the URL permitted address and URL blocking address contained in the catalog storage unit 100. In order to clearly distinguish them, the terms input address, permitted address, and blocking address are imparted to each of them.

Further, the URL input address processing unit 200 is equipped with an algorithm (Parser) that interprets the syntax of the URL input address transmitted from the Internet browser 500 in order to efficiently compare URL permitted addresses and URL blocking addresses. Thereby, the URL input address processing unit 200 separates and processes the URL input address into protocol, host address, and actual address.

For example, if the URL input address transmitted to the URL input address processing unit 200 to the user is which attempts to connect “https:/comic.OOO.com/webtoon/list?titled=711422”, the protocol is separated as “https:”, the host address as “comic.OOO.com”, and the actual address as “comic.OOO.com/webtoon/list?titled=711422”. Here, it may be desirable to delete the “www” that often appears before the URL input address and the “/” at the end of the address because they are unnecessary elements for determining permission/blocking of website access.

Here, the protocol is used to check whether the address is for accessing an external website, and for the case of a protocol used for packet transmission inside the browser 500, the access management device 10 of the present invention is not operated because there is no need to determine the permission/blocking of the website access. Typically, if the URL input address includes the “http:” or “https:” protocols at the beginning, the access management device 10 of the present invention will operate.

In addition, the URL input address processing unit 200 separates the host address from the actual address in order to enable more precise management of website access permission/blocking. In particular, the host address is the address that serves as the standard for determining whether a website is a single host or a multi-host, and is proactively determined before deciding whether to permit or block website access to the actual address to which the user attempts to connect.

Here, “multi-host” is a term introduced herein as a concept to distinguish host addresses from the general “single host (single host & single service)” having a single purpose in the existing concept, and a host that provides multiple services such as shopping, blogs, and news to a single host address, such as a portal site, has been newly defined as a “multi-host (single host & multi services).”

Then, the permission/blocking determination unit 300 thereby refers to a configuration equipped with a determination algorithm, which loads the permitted catalog 110 and the blocking catalog 120 stored in the catalog storage unit 100, receives input of the URL input address that has been separated and processed by the URL input address processing unit 200 in response to this, and cross-compares, based on this, the URL permitted address and URL blocking address on the catalog storage unit 100 loaded for the URL input address, to thereby derive a result on whether or not to block, that is, a result of whether to permit or block.

Further, the access management device 10 of the present invention may be realized as a hardware or a combination of hardware and software suitable for a specific application. Here, the hardware includes both general-purpose computer devices such as personal computers and mobile communication terminals, and enterprise-specific computer devices, and a computer device may be realized as a device including memory, microprocessor, microcontroller, digital signal processor, application integrated circuit, programmable gate array, programmable array organization or the like, or a combination thereof. Therefore, it is necessary to have a software configuration that integrally controls the operations of the catalog storage unit 100, URL input address processing unit 200, and permission/blocking determination unit 300. Performing such functions corresponds to the app control unit 400. In addition, the app control unit 400 serves to output the results of permitting (including limited permissions described below) or blocking Internet access determined by the permission/blocking determination unit 300 to the Internet browser 500 or other programs linked to the access management device 10.

On the other hand, the algorithm that derives the result of whether to permit or block access to the website of the URL input address that the user is trying to connect to is explained as follows. Here, the host address and the actual address separately processed and provided by the URL input address processing unit 200 are related to the URL input address, and therefore, host address and real address do not refer to URL permitted addresses and URL blocking addresses. Therefore, in the following description, both the host address and the actual address should be understood as relating to the URL input address.

The permission/blocking determination unit 300 basically utilizes the highest determination condition as to whether the URL address matching the actual address on the URL input address is in the permitted catalog 110 or the blocking catalog 120, and thereby determines whether to permit or block website access. For example, even when the host address is in the permitted catalog 110, if the actual address is in the blocking catalog 120, access to the website will be blocked, and vice versa. In this manner, instead of determining whether or not to permit/block in a one-dimensional manner based on the actual address on the URL input address, it utilizes the actual address as the highest determination condition and comprehensively determines whether to permit or block it, including the host address, thereby being able to create various management scenarios.

And, in a case where the host address on the URL input address is only in the permitted catalog 110, the permission/blocking determination unit 300 permits access to all subdomains and sub-addresses including the corresponding host address unless there are any restrictions on whether to permit/block the actual address (i.e., catalog registration). For example, if OOO.com is registered in the permitted catalog 110, but the URL blocking address accompanying various subdomains and sub-addresses is not registered in OOO.com in the blocking catalog 120, all services such as finance.OOO.com (economic services) and jr.OOO.com (children's services), where the services provided are differentiated by subdomain, are permitted.

On the other hand, the access management device 10 of the present invention can permit two types of special identifiers to be registered in the catalog storage unit 100, which enable more efficient and simple creation of website access permission/blocking scenarios.

The first special identifier is a special identifier that enables the user to specify that the corresponding URL permitted address is a multi-host. As mentioned above, multi-host refers to a website that has the same host address, but distinguishes sub-addresses and sub-domains as separate services and processes them as separate URL addresses. The first special identifier may be defined as a string that does not overlap with the URL address rule, for example, a string such as “!?”, and the user may register a URL address such as “OOO.com!?” in the permitted catalog 110 to thereby specify that the corresponding website is a multi-host.

In response to this, the permission/blocking determination unit 300 determines to permit or block access to the URL input address depending on the permitted catalog 110 and blocking catalog 120, or determines as a limited permission that requires real time content inspection, in a case where the URL input address corresponds to a multi-host to which a first special identifier is imparted.

As mentioned above, the permission/blocking determination unit 300 basically sets as the highest determination condition whether the URL address matching the actual address on the URL input address is in the permitted catalog 110 or the blocking catalog 120 and determines whether to permit or block access to the website. When the URL input address is a multi-host to which a first special identifier is imparted, more systematic access management is preferable because various services are provided with one host address.

For example, if “OOO.com!?” is registered in the permitted catalog 110 and there is no URL blocking address related to that host address in the blocking catalog 120, it is preferable to determine as a limited permission that requires real time content inspection. Due to the variety of services provided by multi-hosts, it is not preferable to permit complete access without protection. In such cases, limited access may be permitted in conjunction with real time harmful content inspection and blocking software, and known software can be applied to real time harmful content inspection and blocking software. For example, the access management device 10 of the present invention can be linked to Korean Patent No. 10-2259730, entitled “An artificial intelligence-based explicit content blocking device,” which is a previously registered patent of the applicant. However, the present invention relates to a device that determines whether or not to access the URL input address that the user attempts to connect to, and is not related to the real time harmful content inspection and blocking algorithm itself, and therefore, a detailed description thereof will be omitted.

As another example, if “OOO.com!?” is registered in the permitted catalog 110 and a subdomain or sub-address containing “OOO.com” is also registered in the bocking catalog 120) as a URL blocking address, access is blocked when the URL input address includes a URL block address on the blocking list 120. However, other websites of “OOO.com” other than subdomains or sub-addresses registered in the blocking catalog 120 are determined as a limited permission that requires real time content inspection. Furthermore, if a URL permitted address that completely matches the actual address is registered in the permitted catalog 110, it is completely permitted without restriction (i.e., without real time content inspection). By introducing the first special identifier in this way, multifaceted access management for multiple hosts becomes possible.

In addition, the catalog storage unit 100 may permit a second special identifier that specifies the blocking of all website access, for example, a second special identifier defined by a string “**” to be registered in the blocking list 120. The second special identifier has a basic policy of blocking access to all websites, but only permits access to specific websites registered in the permitted catalog 110. By introducing a second special identifier, the trouble of having to register a large number of URL blocking addresses in the blocking list 120 is eliminated, which not only improves user convenience but also enables efficient use of the resources of the user device.

If the second special identifier is registered in the blocking catalog 120 in this way, the permission/blocking determination unit 300 permits access only to host addresses or actual addresses registered in the permitted catalog 110 in response thereto.

In addition, the permission/blocking determination unit 300 permits access only to the host address or real address that is identical to the URL permitted address registered in the permitted catalog 110, while it is also possible to block access to the host address or real address that is identical to the URL blocking address registered in the blocking list 120. In other words, a second special identifier is registered in the blocking catalog 120 and thus access is allowed to the URL permitted address in the permitted registration, but if a sub-address including a URL-permitted address is registered in the blocking list 120, access to the sub-address registered as this URL-blocking address (sub-address including URL permitted address) can be blocked.

If a second special identifier that specifies total blocking is introduced into the access management device 10 of the present invention in this way, user convenience and resource management of the user device can be improved, and the permitted catalog 110 can combine with the blocking catalog 120, which becomes possible to realize various access management scenarios that the user can imagine.

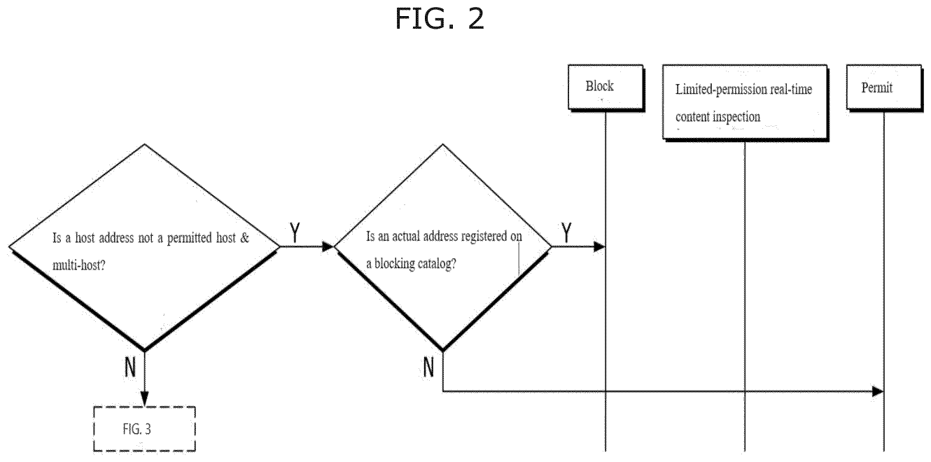

The access management device 10 of the present invention as described above, especially the permission/blocking determination unit 300, can be realized as various algorithms depending on the program creator, and one example thereof is shown in FIGS. 2 to 6. The algorithm of the illustrated permission/blocking determination unit 300 targets the catalog storage unit 100 to which both the first and second special identifiers are applied, and takes into consideration everything from the presence/absence of permission/blocking to host addresses and the presence/absence of multiple hosts.

FIG. 2 shows the state that the permission/blocking determination unit 300 determines first, which corresponds to a case where the host address is in the permitted catalog 110 but is not a multi-host. If the host address is in the permitted catalog 110, there is no need to determine the presence or absence of a second special identifier on the blocking catalog 120, and since it is not a multi-host (i.e., if the first special delimiter is not imparted to the URL permitted address), the content to be determined is simple, so that determining whether it is applicable first can make it easier to write an algorithm.

As shown in FIG. 2, if the host address is in the whitelist 110 but is not a multi-host, the permission/blocking determination unit 300 blocks access when the actual address is in the block list 120, and it is determined to permit access in other cases.

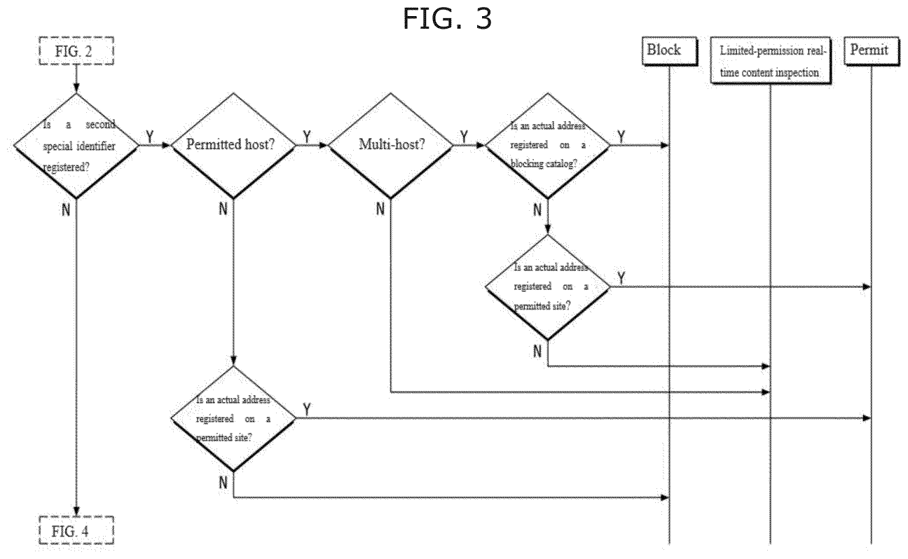

If it does not correspond to FIG. 2, that is, if the host address is in the permitted catalog 110 but is not a multi-host, the process proceeds to the determination procedure shown in FIG. 3 and subsequent steps. Referring to FIG. 3, the permission/blocking determination unit 300 first determines whether or not a second special identifier specifying all blocking is registered in the blocking catalog 120, when the host address is in the permitted catalog 110 and is not a multi-host (not applicable to FIG. 2), FIG. 3 shows a case where a second special identifier is registered in the blocking catalog 120, wherein the permission/blocking determination unit 300 determines whether the host address is registered in the permitted catalog 110, and check whether it is a multi-host if it is a permitted host address, while it permits access to only if the actual address s in the permitted catalog 110, in a case where it is a host address registered in the blocking catalog 120, and other actual addresses are blocked.

Further, the permission/blocking determination unit 300 permits access only when the actual address is not in the blocking catalog 120 but is in the permitted catalog 110, in the case of a multi-host whose host address is registered in the permitted catalog 110. And, if the host address is a single host registered in the permitted catalog 110, it is determined to be a limited permission that requires real time content inspection.

On the other hand, the permission/blocking determination unit 300 may determine a limited permission that requires real time content inspection, in a case where the host address is a multi-host registered in the permitted catalog 110 and the actual address is neither in the blocking catalog (120) nor the permitted catalog 110, and a detailed description thereof is the same those described above.

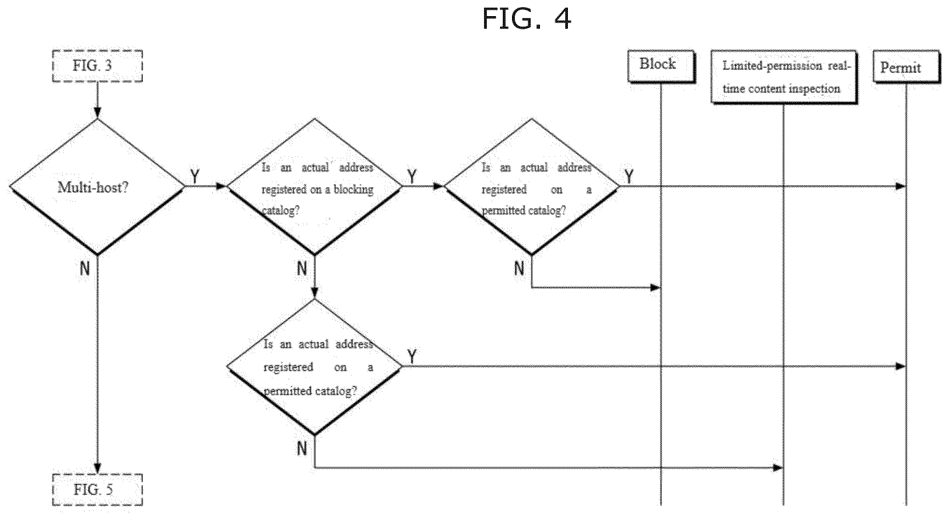

Further, if it is confirmed that the second special identifier is not registered in the blocking catalog 120, the process branches directly to the determination procedure of FIG. 4 without going through the determination procedure of FIG. 3. According to FIG. 4, the permission/blocking determination unit 300 determines whether the host address is a multi-host, when the second special identifier is not registered in the blocking catalog 120, and permits access only if the actual address is in the permitted catalog 110, in the case of multi-host.

In addition, even if a URL blocking address that includes a sub-address is registered in the blocking catalog 120, the permission/blocking determination unit 300 permits access if the actual address is in the permitted catalog 110, and is determined as a limited permission that requires real time content inspection, considering the service characteristics of multi-hosts.

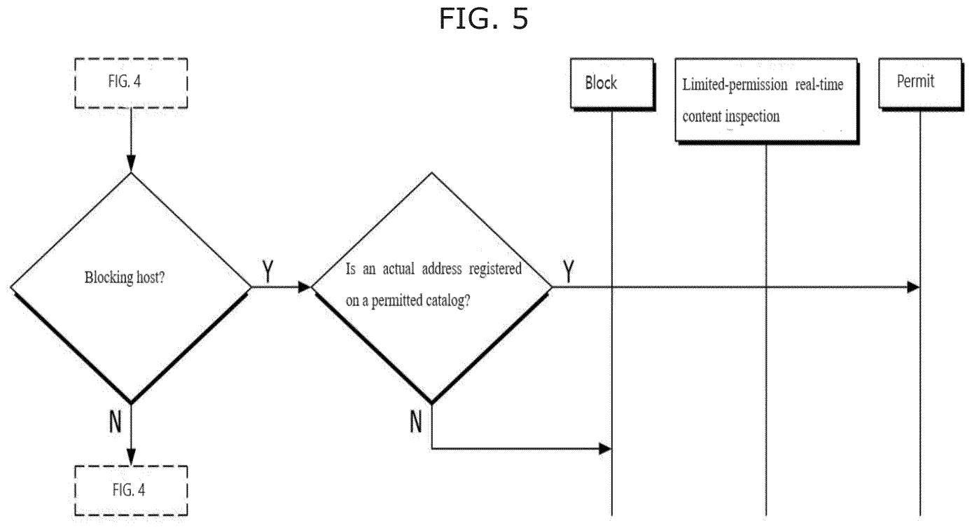

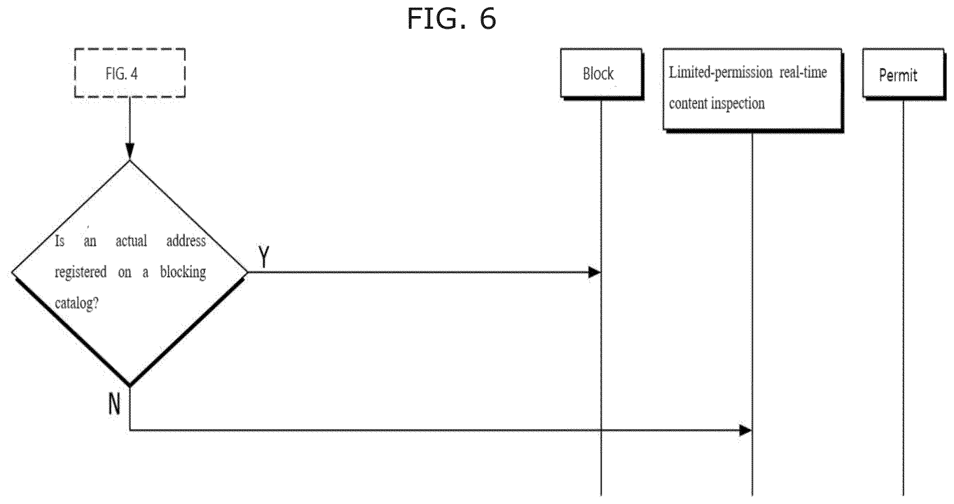

In addition, in the remaining cases where the URL input address does not even apply to the determination procedure in FIG. 4, it relates to a host address in which the first and second special identifiers are not used, that is, a single host address for which total blocking is not set, and the remaining determination procedure is shown in FIGS. 5 and 6. Each determination procedure in FIGS. 5 and 6 is distinguished depending on whether a single host address is in the blocking catalog 120.

FIG. 5 shows a case where the second special identifier is not registered in the blocking catalog 120 and the host address is a single host in the blocking catalog 120, in which case the permission/blocking determination unit 300 determines that access is permitted only when the actual address is in the permitted catalog 110.

Further, FIG. 6 shows a case where the second special identifier is not registered in the block list 120 and the host address is a single host that is not in the blocking catalog 120, wherein it is determined as a limited permission that requires real time content inspection as long as the actual address is not in the blocking catalog 120.

In this way, the access management device 10 of the present invention newly defines a host that provides multiple services such as shopping, blogs, and news to one host address, such as a portal site, as a “multi-host”, uses one criterion on whether to permit or block it, and cross-compares the URL input address with the permitted catalog 110 and the blocking catalog 120 to determine in various ways whether to permit or block access to the URL input address, thereby making it possible to realize various access management scenarios intended by the user.

On the other hand, computer software, instructions, codes, and the like for implementing the access management device 10 of the present invention can be stored or accessed by a readable device, wherein the readable device may include a computer component containing digital information used for computing for a fixed time interval, semiconductor storage such as RAM or ROM, permanent storage such as optical disks, large capacity storage such as hard disks, tapes, drums, etc., optical storage such as CDs or DVDs, and memory such as flash memory, floppy disk, magnetic tape, paper tape, independent RAM disk, large-capacity storage removable from the computer, dynamic memory, static memory, variable storage, and network-attached storage such as the cloud. On the other hand, the commands and codes used herein include all languages, including information-oriented languages such as SQL, dBase, etc., system languages such as C, Objective C, C++, assembly, etc. architectural languages such as Java, NET, etc., and application languages such as PHP, Ruby, Perl, Python, etc., but are not limited thereto, and may include all languages widely known to those skilled in the art in the technical field to which the proposed invention belongs.

In addition, “computer-readable media” as used herein includes any available media that contribute to providing instructions to the processor for program execution. Specifically, the media includes non-volatile media such as information storage devices, optical disks, magnetic disks, etc., volatile media such as dynamic memory, etc., and transmission media such as coaxial cable, copper wire, optical fiber, etc. that transmit information, but are not limited thereto.

The invention has been described in detail with reference to the drawing and embodiments. However, it should be appreciated that the embodiments described herein and the configurations shown in the drawings are only embodiments of the present invention and do not represent the entire spirit of the present invention, and thus, there may be various equivalents and modifications that can replace the embodiments and the configurations at the time at which the present application is filed.

### DESCRIPTION OF REFERENCE NUMERALS

10: access management device
100: catalog storage unit
110: permitted catalog
112: default permitted catalog
114: user setting permitted catalog
120: blocking list
122: default blocking list
124: user setting blocking catalog
200: URL input address processing unit
300: permission/blocking determination unit
400: app control unit
500: internet browser

1. A device for managing website access blocking and permission, comprising:
a catalog storage unit that stores a permitted catalog containing URL-permitted addresses of specific websites that permit access, and a blocking catalog containing URL blocking addresses of specific websites that blocks access;
a URL input address processing unit that receives transmission of a URL input address inputted or processed on an Internet browser and separately processes the transmitted URL input address into a protocol, a host address, and an actual address;
a permission/blocking determination unit equipped with a determination algorithm that loads the permitted catalog and blocking catalog stored in the catalog storage unit, receives the URL input address separately processed in the URL input address processing unit, and cross-compares the URL permitted address and URL blocking address on the catalog storage unit loaded for the URL input address to thereby derive a result on whether to permit or block access to the website connected by the URL input address; and
an app control unit that integrally controls operations of the catalog storage unit, URL input address processing unit, and permission/blocking determination unit.

2. The device for managing website access blocking and permission as claimed in claim 1, wherein:
the permission/blocking determination unit determines whether to permit or block access to a website by using as the highest determination condition where the URL address matching the actual address on the URL input address is located in the permitted catalog or blocking catalog.

3. The device for managing website access blocking and permission as claimed in claim 2, wherein:
the permission/blocking determination unit permits access to all subdomains and sub-addresses including the host address, in a case where the host address on the URL input address is only in the permitted catalog.

4. The device for managing website access blocking and permission as claimed in claim 2, wherein:
the catalog storage unit comprises,
a default permitted catalog and a default blocking catalog that cannot be changed by the user, and
a user-setting permitted catalog and a use-setting blocking catalog that can be changed by the user.

5. The device for managing website access blocking and permission as claimed in claim 4, wherein:
the catalog storage unit permits assigning a first special identifier to the permitted catalog, wherein the first special identifier specifies that the host address is the same, but the sub-address and subdomain are separate services and are processed as separate URL addresses,
the permission/blocking determination unit determines that the multi-host to which the first special identifier has been assigned permits or blocks access to the URL input address, or permits as limited access requiring real time content inspection, depending on the permitted catalog and the blocking catalog.

6. The device for managing website access blocking and permission as claimed in claim 5, wherein:
the catalog storage unit permits registering a second special identifier that specifies blocking of access to all websites in the blocking catalog, and
the permission/blocking determination unit permits access only to the host address or real address registered in the permitted catalog, in a case where the second special identifier is registered in the blocking catalog.

7. The device for managing website access blocking and permission as claimed in claim 6, wherein:
the permission/blocking determination unit permits access only to a host address or real address that is the same as the URL permission address registered in the permitted catalog, while it blocks access to a host address or actual address that is the same as the URL blocking address registered in the blocking catalog, in a case where the second special identifier is registered in the block catalog.

8. The device for managing website access blocking and permission as claimed in claim 6, wherein:
the permission/blocking determination unit first determines whether the host address is not a multi-host while being in the permitted catalog, blocks access when the actual address is in the blocking catalog in the case of corresponding thereto, while it permits access in the other cases.

9. The device for managing website access blocking and permission as claimed in claim 8, wherein:
the permission/blocking determination unit first determines whether the second special identifier is registered in the blocking catalog, when the host address is in the permitted catalog but does not correspond to the case where it is not a multi-host, and
it determines whether the host address is registered in the permitted catalog when a second special identifier is registered, and then checks whether it is a multi-host in the case of permitted host address, while it permits access only when the actual address is in the permitted catalog in the case of a blocked host address.

10. The device for managing website access blocking and permission as claimed in claim 9, wherein:
the permission/blocking determination unit permits access only when the actual address is not on the blocking catalog but is on the permitted catalog, in the case of a multi-host in which a second special identifier is registered and the host address is registered in the permitted catalog, and
it determines as a limited permission that requires real time content inspection, in the case of a single host in which a second special identifier is registered and the host address is registered in the permitted catalog.

11. The device for managing website access blocking and permission as claimed in claim 10, wherein:
the permission/blocking determination unit determines as a limited permission that requires real time content inspection, in a case where the second special identifier is registered and the host address is a multi-host registered in the permitted catalog, and at the same time, the actual address is not in both the blocking catalog and the permitted catalog.

12. The device for managing website access blocking and permission as claimed in claim 9, wherein:
the permission/blocking determination unit determines whether the host address is a multi-host when the second special identifier is not registered in the blocking catalog, and
it permits access only when the actual address is on the permitted catalog in a case where the address is a multi-host.

13. The device for managing website access blocking and permission as claimed in claim 12, wherein:
the permission/blocking determination unit permits access when the real address is in the permitted catalog even if a URL blocking address including a sub-address in the real address is registered in the blocking catalog.

14. The device for managing website access blocking and permission as claimed in claim 13, wherein:
the permission/blocking determination unit determines as a limited permission that requires real time content inspection, in a case where the URL blocking address including a sub-address in the real address is not registered in the blocking catalog and the real address is not even in the permitted catalog.

15. The device for managing website access blocking and permission as claimed in claim 9, wherein:
the permission/blocking determination unit permits access only when the actual address is in the permitted catalog, in a case where the second special identifier is not registered in the blocking catalog and the host address is a single host in the blocking catalog.

16. The device for managing website access blocking and permission as claimed in claim 15, wherein:
the permission/blocking determination unit determines as a limited permission that requires real time content inspection unless the actual address is on the blocking catalog, in a case where the second special identifier is not registered in the blocking catalog and the host address is a single host that is not in the blocking catalog.
